(19) United States
(12) Patent Application Publication
(10) Pub. No.: US 2004/0041742 A1
(43) Pub. Date: Mar. 4, 2004

(54) Low-loss IR dielectric material system for broadband multiple-range omnidirectional reflectivity

(76) Inventors: Yoel Fink, Brookline, MA (US); Burak Temelkuran, Boston, MA (US); Shandon Hart, Cambridge, MA (US); Edwin L. Thomas, Natick, MA (US); John D. Joannopoulos, Belmont, MA (US); Mihai Ibanescu, Piatra Neamt (RO); Marin Soljacic, Somerville, MA (US)

Correspondence Address: Samuel, Gauthier & Stevens LLP, Suite 3300, 225 Franklin Street, Boston, MA, 02110, US

(21) Appl. No.: 10/349,290

(22) Filed: Jan. 22, 2003

Related U.S. Application Data
(60) Provisional application No. 60/350,728, filed on Jan. 22, 2002.

(51) Int. Cl. H01Q 15/14

(52) U.S. Cl. 343/912

(57) ABSTRACT

A multiple-range omnidirectional reflector includes a plurality of bilayers. Each of the bilayers includes a first layer comprising of a low absorption and low refractive index material and a second layer comprising of a high refractive index and low absorption material. Varying the thickness of one or more of the bilayers produces multiple omnidirectional reflecting ranges.

### PRIORITY INFORMATION

This application claims priority from provisional application Ser. No. 60/350,728 filed Jan. 22, 2002, incorporated herein by reference in its entirety.

### BACKGROUND OF THE INVENTION

The invention relates to the field of broadband thermal IR applications, and in particular to low-loss IR dielectric material system for broadband dual range omnidirectional reflectivity.

Photonic crystals are periodic structures that inhibit the propagation of electromagnetic waves of certain frequencies and provide a mechanism for controlling the flow of light. Considerable effort has been devoted to the construction of three-dimensional periodic structures at length scales ranging from the microwave to the visible. However, technological difficulties and the cost of fabrication severely limit the utilization of these 3D structures for thermal and optical frequency applications. Two-dimensional periodic structures that can confine the light in the plane of periodicity only, and which are easier to fabricate have also been investigated.

Recently, it has been shown both experimentally and theoretically, that under certain conditions, a one-dimensional periodic structure could be used to reflect EM waves incident from all directions and any polarization. This structure, which is simple to fabricate, leads naturally to many application opportunities, including telecommunications, optoelectronics, and thermal radiation. Nevertheless, a critical issue involves the choice of materials and their processing.

Many of the useful properties of photonic crystals depend on the gap size, which increases with increasing index contrast. In order to achieve high reflectivity values, the evanescent decay length needs to be smaller than that absorption length. Hence large index contrast and low absorption material systems are preferred.

With a high refractive index and very low absorption, tellurium (Te) is a suitable choice of material for these structures. Previously, Te and polystyrene materials systems were used to fabricate an omnidirectional photonic crystal at thermal wavelengths. However, because of a large number of vibrational absorption modes, polystyrene is not the best choice for achieving high reflectivities across a wide range of the IR portion of the spectrum.

Identifying a low index, low loss material at thermal wavelengths that can be easily processed and that have good mechanical environmental stability is challenging. Typical inorganic low index materials either have absorption problems at these thermal wavelengths, such as oxides, or simply they are not suitable for thin film applications due to material properties, such as salts, which are water soluble but typically have substantial absorption bands in the IR range associated with the chemical and structural complexity of the polymer.

### SUMMARY OF THE INVENTION

According to one aspect of the invention, there is provided a multiple-range omnidirectional reflector. The omnidirectional reflector includes a plurality of bilayers. Each of the bilayers includes a first layer comprising of a low absorption and low refractive index material and a second layer comprising of a high refractive index and low absorption material. Varying the thickness of one or more of the bilayers produces multiple omnidirectional reflecting ranges.

According to another aspect of the invention, there is provided a method of providing multiple-range omnidirectional reflectivity in an omnidirectional reflector. The method includes providing a plurality of bilayers. Each of the bilayers includes a first layer comprising of a low absorption and low refractive index material and a second layer comprising of a high refractive index and low absorption material. Furthermore, the method includes varying the thickness of one or more of the bilayers so that multiple omnidirectional reflecting ranges are produced.

### BRIEF DESCRIPTION OF THE DRAWINGS

FIG. 1 is a graph of an imaginary part of the reflective index k describing the absorption properties of polystyrene and polyethylene;

FIG. 2 is a schematic block diagram of an exemplary PE-Te material system;

FIGS. 3A-3B are band diagrams associated with the PE-Te material system;

FIGS. 4A-4B are graphs of the reflection spectra for a 9-layer PE-Te materials structure;

FIGS. 5A-5C are graphs associated with Transverse Magnetic (TM) polarized waves of a twenty-layer PE-Te material structure; and

FIGS. 6A-6C are graphs associated with Transverse Electric (TE) polarized waves of the twenty-layer PE-Te material structure, described in FIGS. 5A-5C.

### DETAILED DESCRIPTION OF THE INVENTION

Polyethylene (PE) has very low absorption across a large frequency range starting from near the IR up to microwave frequencies due to its simple —CH₂-repeating structure. This property, when combined with its stability, makes it an ideal candidate for IR applications. However, thin film processing of linear chain PE is complicated by the formation of crystalline spherulitic structure, which tends to scatter light strongly and prevents the formation of transparent films. By adding side branches to linear PE, one is able to inhibit crystallization and substantially reduce scattering. In order to make micrometer thick films of PE, first prepare a 5% branched PE solution in xylene at 50° C. A film with a thickness of 1 μm is spun cast from the hot solution at 1300 rpm onto a silicon substrate. The resulting film is uniform, highly transparent, and has a surface roughness around 350 Å rms.

The transmission and reflection properties of photonic crystals are measured using a Fourier Transform Infrared Spectometer, a polarizer, and an angular reflectivity stage, and a Nicolet Infrared Microscope. A gold mirror is used as a background standard for the reflectance measurements.

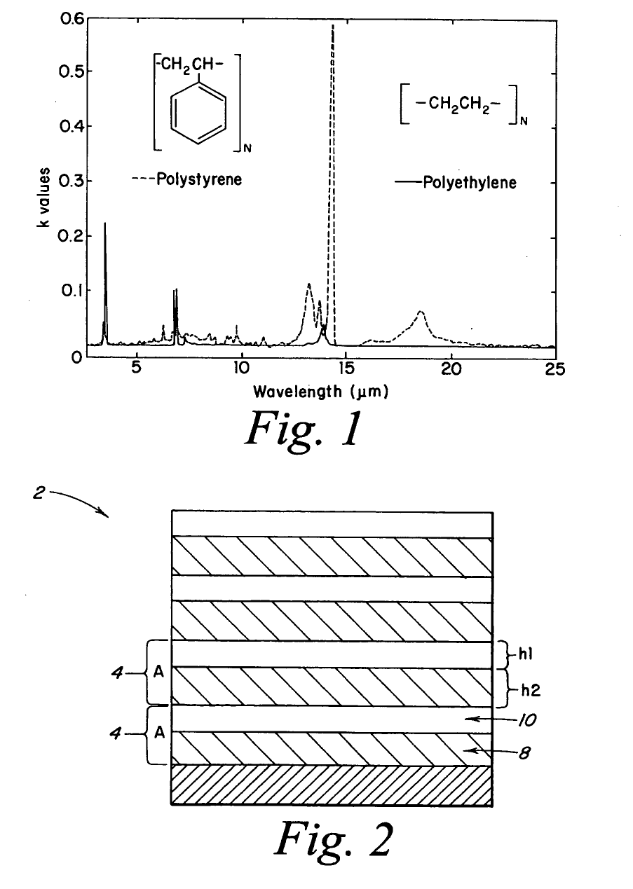

FIG. 1 is a graph of an imaginary part of the reflective index k describing the absorption properties of polystyrene and PE. The k values are calculated using transmission and reflection measurements for both polystyrene and PE. The molecular structures for both polystyrene and PE are exhibited. The low absorption values of PE when compared to polystyrene, are a result of the simplicity of the molecular structure of PE. The spectrum for the PE exhibits absorption resonances only at 3.4 μm (2920 cm⁻¹ C—H stretch mode), 6.9 μm (1450 cm⁻¹ CH₂ scissor), and 13.9 μm (720 cm⁻¹ CH₂ rock twist). A PE-Te material system can be used to build an omnidirectional reflector at thermal wavelengths. However, other material systems that inhibit similar properties can also be used.

FIG. 2 is a schematic block diagram of an exemplary PE-Te material system 2 with alternating layers of Te 10 with refractive index n1 and thickness h1, and PE 8 with refractive index n2 and thickness h2. The electromagnetic mode convention for the incoming wave with the wavevector k is also given. In other embodiments, the thickness h1 and h2 can vary. The formation of an elemental structure having PE-Te is a bilayer 4. The PE-Te material system 2 can include a plurality of bilayers 4. Each of the bilayers 4 can have thicknesses A, which includes the thickness h1 and h2 of PE 8 and Te 10, respectively. The varying of the thickness A of the bilayer 4 provides for interesting properties in forming an omnidirectional reflector, in particular creating an extended omnidirectional reflectivity range, which will be discussed more below.

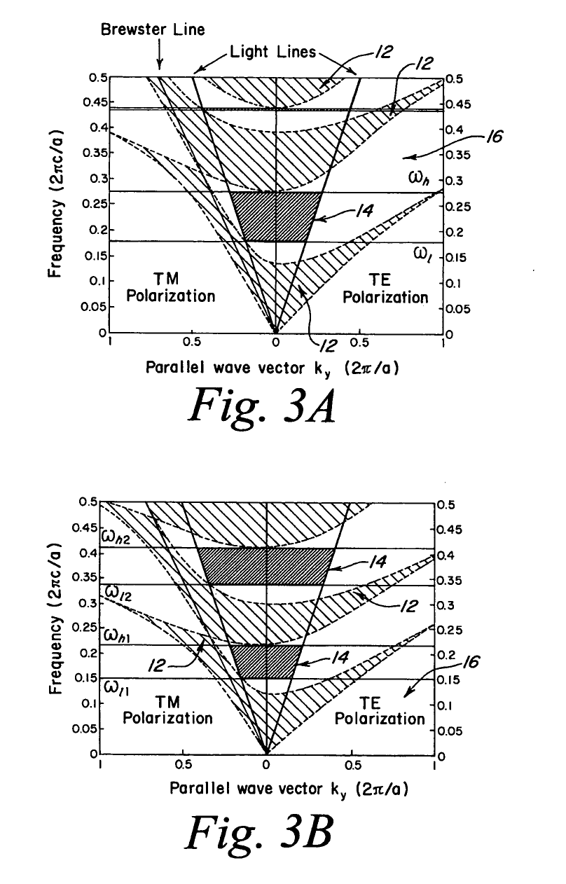

FIGS. 3A-3B are band diagrams associated with the PE-Te material system 2. FIG. 3A shows the projected band diagram for such a structure where the thickness ratio of the two materials is chosen to give a broadband omnidirectional reflector. In this diagram, the areas 12 highlight regions of propagating states, whereas areas 16 represent regions containing evanescent states. The areas 14 represent the omnidirectional reflection region. Using the film parameters of n1=4.6 for thermally evaporated Te and n2=1.5 for PE, an omindirectional reflecting region denoted with area 14, for film thickness ratio of h2(PE)/h1(Te)=1.7/0.68 is shown. The omnidirectional range has a value of 44% for the system, which is also verified by fabricating this structure and measuring the reflectivity for both polarizations at various angles (from 0 to 80 degrees).

The omnidirectional region for the first design exhibits a wide primary gap, but the secondary gap is very narrow, as shown in FIG. 3A. Other designs can be used to obtain two separate broad reflection regions, using only a single stack of nine layers. Obtaining a broad stopband in two different frequency regions using only a single stack can be of great interest for many practical purposes, for example, a reflective device functional in both solar and atmospheric windows.

In order to achieve these properties, varying the thicknesses of one or more bilayers of the PE-Te material system can form a structure whose secondary gap is considerably extended. This occurs when the PE thickness h1 is similar to the thickness h2 of Te.

FIG. 3B shows a band diagram for a structure where the thickness ratio is chosen as h2(PE)/h1(Te)=1.1/0.8. The characteristic dimensionless parameter η₁=2 (ωₕᵢ−ωₗᵢ)/(ωₕᵢ−ωₗᵢ) (i=1,2), which quantifies the extent of the two omnidirectional ranges, has a value of 42% for the first band (lower frequency band), and 22% for the second band (higher frequency band).

When fabricating this new system, a Te layer thickness of 0.8 μm and a PE layer thickness of 1.1 μm can be used.

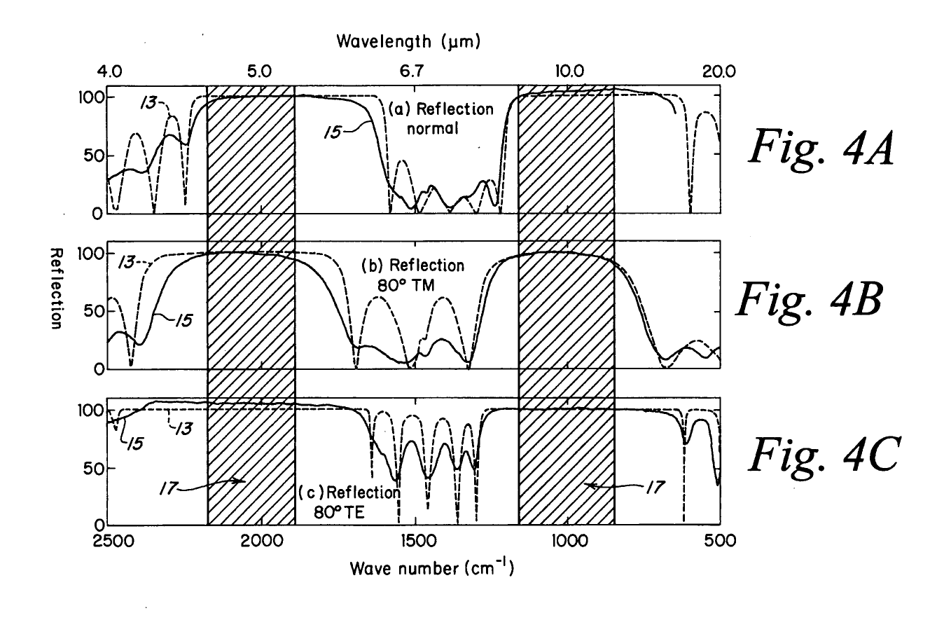

FIGS. 4A-4B are graphs of the reflection spectra for a 9-layer PE-Te material structure. The graph demonstrates both theoretical and experimental results. As can be seen from FIG. 3B, the reflection at normal incidence, which sets the shorter wavelength limits ωₕ₂ and ωₗ₂, and the reflection of the Transverse Magnetic (TM) polarized wave at a high angle to determine the omnidirectional reflectivity range for both bands. The maximum due to experimental limitations is 80 degrees, which sets the upper wavelength limits ωₗ₁ and ωₗ₂.

FIGS. 4A-4C demonstrates the experimental 15 and theoretical 13 results at normal incidence TM, at 80 degrees TM, and 80 degrees Tranverse Electric polarization (TE).

As expected, the reflection ranges are shown by region 17, the fundamental omnidirectional region extends from 1220 cm-1 to 800 cm-1, (40% range to midrange ratio), whereas the secondary omnidirectional region extends from 2200 cm-1 to 1820 cm-1 (20% range to midrange ratio). The measured values of range to midrange ratio are in good agreement with the ones calculated using the band diagram. The measured reflectivity in the intermediate angles gave similar high reflection values for the whole band gap range denoted by the shared area in FIG. 4 for both polarizations. There is very good agreement between the measured and simulated reflections spectra. The high reflectivity at all angles and both polarizations within the omnidirectional band gap for this structure is good verification of this new low loss material system being proper for many applications. Moreover, the good film properties of PE yield a freestanding flexible PE-Te stack.

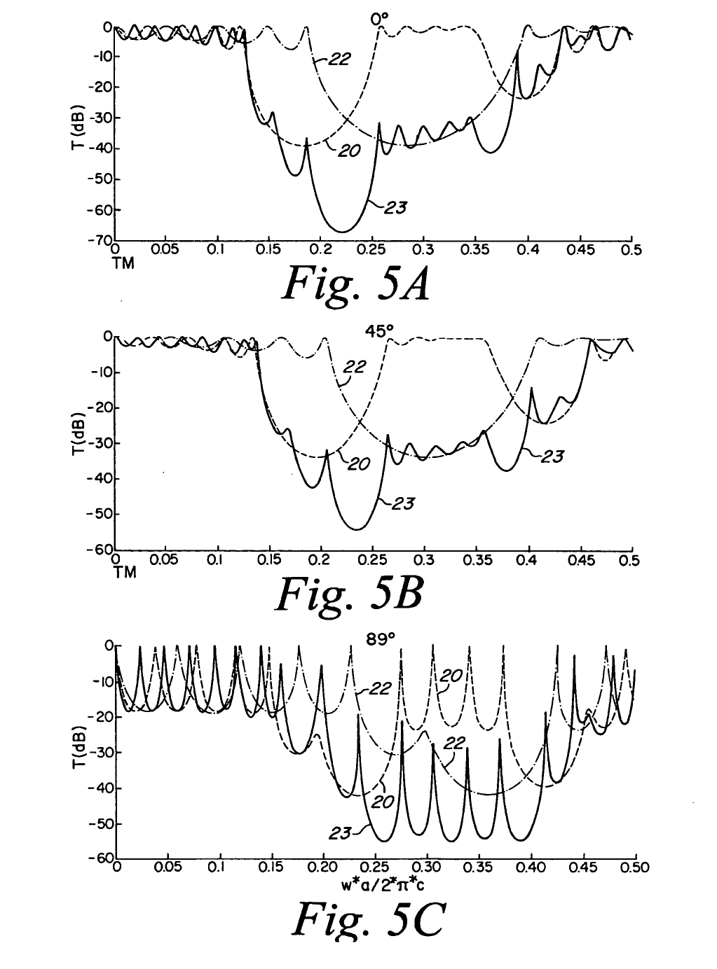

FIGS. 5A-5C are graphs associated with TM polarized waves of a twenty-layer PE-Te material structure. The PE-Te material structure includes 5 bilayer structures having indices of 4.6 for PE and 1.6 for Te, respectively. The next 5 bilayers structures also have indices of 4.6 for PE and 1.6 for Te, respectively. Moreover, the thickness of each PE layer associated with the first 5 bilayers is A*⅓,

where A is the thickness of each of the first 5 bilayers. The thickness of each Te layer associated with the first 5 bilayers is A*⅔.

Furthermore, the thickness of each PE layer associated with the last 5 bilayers is 0.65*A*1/3, and the thickness of each Te layer associated with the last 5 bilayers is 0.65*A*⅔. The thickness of each bilayer associated with the last 5 bilayers is 0.65*A. In this embodiment, the thickness A can be 5.79 μm, however, other values of thickness A can be used.

FIGS. 5A-5C shows TM polarized waves at several angles of incidence, such as 0, 45, and 89 degrees. The twenty-layer arrangement described hereto and shown in FIGS. 5A-5C has an omnidirectional reflecting range approximately between 0.15 and 0.44. FIGS. 5A-5C also demonstrate the TM polarized waves associated with the first 5 bilayers and second 5 bilayers of the twenty-layer PE-Te material structure shown by elements 20 and 22. The combination of the properties associated with the TM polarized waves for the first 5 bilayers and second 5 bilayers produces the overall property of the twenty-layer structure shown by element 23.

Combining the omnidirectional reflecting ranges of the first 5 bilayers and second 5 bilayers forms the omnidirectional reflecting range of the overall 20-layer PE-Te material structure. By varying the thickness of the bilayers, one can change the size of the omnidirectional reflecting range of the overall twenty-layer PE-Te material system of the TM polarized waves without requiring sophisticated fabrication techniques or processing. The invention also allows for the creation of larger layered structures that can include a multitude of varying layer thicknesses to define extended or multiple omnidirectional reflecting ranges in the TM domain. Furthermore, in other embodiments, the omnidirectional reflecting ranges of various bilayer structures do not need to overlap, they can also be mutually distinct omnidirectional non-overlapping ranges. The invention permits multiple omnidirectional ranges to co-exist in a PE-Te material system in the TM domain, which can overlap or be mutually distinct depending on the thickness of selective bilayers and other parameters in the PE-Te material system.

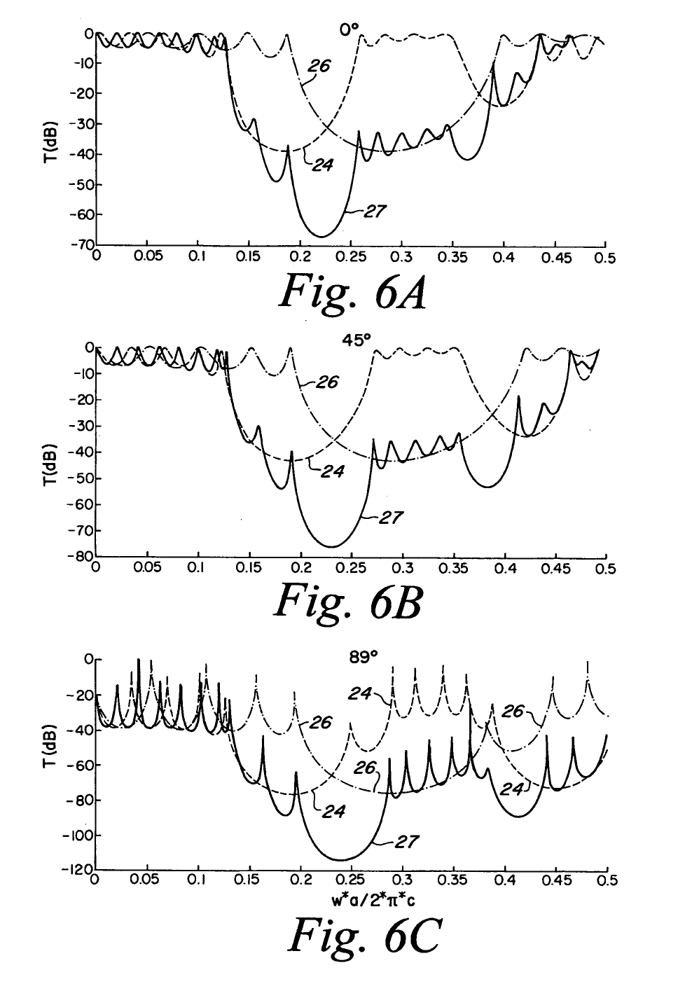

FIGS. 6A-6C are graphs associated with TE polarized waves of the twenty layer PE-Te materials structure, described in FIGS. 5A-5C. FIGS. 6A-6C shows TE polarized waves at several angles of incidence, such as 0, 45, and 89 degrees. The twenty-layer arrangement described hereto and shown in FIGS. 5A-5C has an omnidirectional reflecting range approximately between 0.15 and 0.44. FIGS. 6A-6C also demonstrate the TE polarized waves associated with the first 5 bilayers and second 5 bilayers shown by elements 24 and 26. The combination of the properties associated with the TE polarized waves for the first 5 bilayers and second 5 bilayers produces the overall property of the twenty-layer structure shown by element 27 in FIGS. 6A-6C.

Combining the omnidirectional reflecting ranges of the first 5 bilayers and second 5 bilayers forms the omnidirectional reflecting range of the overall inventive PE-Te material structure. By varying the thickness of the bilayers, one can change the size of the omnidirectional reflecting range of the overall twenty-layer PE-Te material system of the TE polarized waves without requiring sophisticated fabrication techniques or processing. The invention also allows for the creation of larger layered structures that can include a multitude of varying layer thicknesses to define extended or multiple omnidirectional reflecting ranges in the TE domain. Furthermore, other material systems with similar properties can be used in place of the PE-Te material system. Furthermore, in other embodiments, the omnidirectional reflecting ranges of various bilayer structures do not need to overlap, they can also be mutually distinct omnidirectional non-overlapping ranges. The invention permits multiple omnidirectional ranges to co-exist in a PE-Te material system in the TE domain, which can overlap or be mutually distinct depending on the thickness of selective bilayers and other parameters in the PE-Te material system.

The invention can be used as a low-loss all dielectric material system to fabricate omnidirectional reflectors at a very large broadband frequency range. Using the inventive PE-Te material system to investigate the formation and broadening the omnidirectional reflecting range provides significant advantages not present in the prior art. This new structure with the property of reflecting at two different regions can be used for various applications, such as in communication at atmospheric windows and waveguides with the property of omnidirectional guiding at two different regions.

Furthermore, the PE-Te material structure can be used to form wavelength-scalable externally reflecting textile fibers or hollow optical waveguiding fibers with large omnidirectional ranges. The confinement of light in the hollow core is provided by the large omnidirectional range established by the alternating layers of the PE-Te bilayers. The fundamental and high-order omnidirectional reflectivity ranges are determined by the layer dimensions and can be scaled, for example, 0.75 to 10.6 μm in wavelength.

Although the present invention has been shown and described with respect to several preferred embodiments thereof, various changes, omissions and additions to the form and detail thereof, may be made therein, without departing from the spirit and scope of the invention.

What is claimed is:

1. A multiple-range omnidirectional reflector comprising:
a plurality of bilayers, wherein each of said bilayers includes a first layer comprising a low absorption and low refractive index material and a second layer comprising a high refractive index and low absorption material, wherein multiple omnidirectional reflecting ranges are produced by varying the thickness of one or more of said bilayers.

2. The multiple-range omnidirectional reflector of claim 1, wherein said first layer and second layer have a defined thickness.

3. The multiple-range omnidirectional reflector of claim 2, wherein said first layer comprises Te.

4. The multiple-range omnidirectional reflector of claim 3, wherein said second layer comprises PE.

5. The multiple-range omnidirectional reflector of claim 4, wherein said first layer has a thickness of 0.8 μm.

6. The multiple-range omnidirectional reflector of claim 5, wherein said second layer has a thickness of 1.1 μm.

7. The multiple-range omnidirectional reflector of claim 6, wherein said reflection range of said multiple-range omnidirectional reflector is extended between 1200 to 800 cm⁻¹.

8. The multiple-range omnidirectional reflector of claim 1, wherein said bilayers comprise a first set of 5 bilayers and a second set of 5 bilayers.

9. The multiple-range omnidirectional reflector of claim 8, wherein said first layer of each of said first and second set of 5 bilayers comprises Te.

10. The multiple-range omnidirectional reflector of claim 9, wherein said second layer of each of said first and second set of 5 bilayers comprises PE.

11. The multiple-range of omnidirectional reflector of claim 10, wherein said second set of 5 bilayers comprises a thickness that is 65% of the thickness of said first set of bilayers.

12. The multiple-range omnidirectional reflector of claim 11, wherein said high refractive index of said first layer of each of said first and second set of 5 bilayers is 4.6.

13. The multiple-range omnidirectional reflector of claim 12, wherein said low refractive index of said second layer of each of said first and second set of 5 bilayers is 1.6.

14. A method of providing multiple-range omnidirectional reflectivity in an omnidirectional reflector, said method comprising:
providing a plurality of bilayers wherein each of said bilayers includes a first layer comprising of a low absorption and low refractive index material and a second layer comprising of a high refractive index and low absorption material; and
varying the thickness of one or more of said bilayers so that multiple omnidirectional reflecting range are produced.

15. The method of claim 14, wherein said first layer and second layer have a defined thickness that in combination equals to the thickness of a bilayer.

16. The method of claim 15, wherein said first layer comprises Te.

17. The method of claim 16, wherein said second layer comprises PE.

18. The method of claim 17, wherein said first layer has a thickness of 0.8 μm.

19. The method of claim 18, wherein said second layer has a thickness of 1.1 μm.

20. The method of claim 19, wherein said reflection ranges is extended between 1200 to 800 cm⁻¹.

21. The method of claim 14, wherein said bilayers comprise a first set of 5 bilayers and a second set of 5 bilayers.

22. The method of claim 21, wherein said first layer of each of said first and second set of 5 bilayers comprises Te.

23. The method of claim 22, wherein said second layer of each of said first and second set of 5 bilayers comprises PE.

24. The method of claim 23, wherein said second set of 5 bilayers comprises a thickness that is 65% of the thickness of said first set of bilayers.

25. The method of claim 24, wherein said high refractive index of said first layer of each of said first and second set of 5 bilayers is 4.6.

26. The method of claim 25, wherein said low refractive index of said second layer of each of said first and second set of 5 bilayers is 1.6.
